(19) United States
(12) Patent Application Publication
(10) Pub. No.: US 2021/0122242 A1
(43) Pub. Date: Apr. 29, 2021

(54) Motor Vehicle Human-Machine Interaction System And Method

(71) Applicant: Ford Global Technologies, LLC, Dearborn, MI (US)

(72) Inventors: Jack Ding, Nanjing (CN); Chen Tian, Nanjing (CN)

(73) Assignee: Ford Global Technologies, LLC, Dearborn, MI (US)

(21) Appl. No.: 17/073,492

(22) Filed: Oct. 19, 2020

(30) Foreign Application Priority Data
Oct. 24, 2019 (CN) 2019110161252

(51) Int. Cl. B60K 35/00; B60R 16/037

(52) U.S. Cl. CPC B60K 35/00; B60R 16/037; B60K 2370/741; B60K 2370/152; B60K 2370/148; B60K 2370/146; B60K 2370/149

(57) ABSTRACT

A human-machine interaction system for a motor vehicle is disclosed, which comprises: a detection device configured to detect an action of a vehicle occupant; an in-vehicle management system including an interactive device and a processor; the interaction device comprises an operable display area configured to display applications; the processor is communicatively connected to the detection device and is configured to identify identity characteristics of the vehicle occupant and selectively activates the applications in the operable display area according to the action and identity characteristics of the vehicle occupant. The present invention also discloses a corresponding vehicle and method. It is possible to recognize the driver's intention and present relevant functions and/or information to the vehicle driver without affecting the driving safety of vehicle due to the need to operate a complex human-machine interface, and it is possible to provide a better riding experience for vehicle occupants.

### CROSS-REFERENCE TO RELATED APPLICATIONS

The present application claims priority to and the benefit of CN application No. 2019110161252, filed Oct. 24, 2019, which is hereby incorporated by reference herein in its entirety.

### FIELD

The present invention generally relates to vehicle technology field, and more particularly to a motor vehicle human-machine interaction system and method, and to a motor vehicle using the system and method.

### BACKGROUND

In the design and manufacture of modern vehicles, the driving safety of vehicles has always been the focus of motor vehicle manufacturers and consumers. With the development of vehicle design and manufacturing technology, contemporary motor vehicles include more and more vehicle functions to assist drivers in operating their vehicles and give vehicle occupants a better riding experience.

Drivers usually access vehicle functions, applications, and various information through a human-machine interaction function of an in-vehicle management system of vehicle. As vehicle functions, applications, and information become increasingly diverse and complex, drivers may need to use information related to vehicle driving while the vehicle is driving; however, operating the human-machine interaction system for information retrieval during driving will cause distraction and affect safe driving of the driver.

In addition, it is also difficult for vehicle occupants to operate functions related to the comfort of riding such as heating, ventilation and air conditioning (HVAC) systems, in-vehicle entertainment systems, etc., through conventional human-machine interaction systems in unfamiliar vehicles. This makes many vehicle drivers or vehicle occupants unable to make full use of the existing vehicle functions, and also reduces the driver's satisfaction to a certain extent.

Against above background, the present inventor recognizes that there is a need for an improved in-vehicle human-machine interaction system and method to better and more conveniently recognize the driver's intention and present relevant functions and/or information to the vehicle driver without affecting the driving safety of vehicle due to the need to operate a complex human-machine interface, and to provide a better riding experience for vehicle occupants.

### SUMMARY

This application is defined by the appended claims. The present disclosure summarizes aspects of the embodiments and should not be used to limit the claims. Other implementations are contemplated in accordance with the techniques described herein, as will be apparent to those of ordinary skill in the art upon examination of the following drawings and detailed description, and such implementations are intended to be within the scope of this application.

The advantage of the present invention is to provide an intelligent and convenient motor vehicle human-machine interaction system and method, which can recognize vehicle driver or occupant' intention and intuitively and conveniently provide vehicle driver or occupant with functional display and/or functional operation they need.
According to the present invention, there is provided a human-machine interaction system for a motor vehicle, comprising:
   a detection device configured to detect an action of a vehicle occupant; and
   an in-vehicle management system at least comprising:
      an interactive device comprising at least one operable display area configured to display one or more applications; and
      a processor communicatively connected to the detection device and configured to:
         identify identity characteristics of the vehicle occupant, and
         selectively activate the one or more applications in the at least one operable display area according to the action and identity characteristics of the vehicle occupant.

According to an embodiment of the present invention, the applications comprise functional display and/or functional operation associated with an action and identity characteristics of an occupant, and the processor is configured to activate the one or more applications by magnifying the functional display of an application and/or opening the functional operation interface of an application.

According to an embodiment of the present invention, the processor is configured to identify the identity characteristics of the vehicle occupant according to the action of the vehicle occupant, and the identity characteristics include at least one of a male or female driver, a male or female passenger and an adult or a minor passenger.

According to an embodiment of the present invention, the action include line-of-sight, voice, touch, text input, facial expressions or actions, hand gestures or actions, head gestures or actions, and body gestures or actions.

According to an embodiment of the present invention, the detection device is configured to detect an association between the action and at least one application and a confirmation of the association, and send the association and confirmation to the processor.

According to an embodiment of the present invention, the processor is configured to selectively activate the at least one application according to the association and confirmation acquired within a predetermined time and the identity characteristics of the vehicle occupant.

According to an embodiment of the present invention, the processor is configured to: in response to the detection device detects that a vector of the line-of-sight is associated with at least one of a plurality of applications, determine occupant identity according to the vector and activate the application according to the association and the occupant identity.

According to an embodiment of the present invention, when the processor is configured to: in response to the detection device detects that vectors of at least two vehicle occupants' line-of-sight are associated with one or more applications, activate the application associated with the vehicle occupant with a higher priority according to a preset identity characteristics priority.

According to an embodiment of the present invention, the processor is configured to receive and store personal preference settings preset by the vehicle occupant, and apply the personal preference settings according to the action and identity characteristics of the vehicle occupant.

According to an embodiment of the present invention, the processor is configured to use historical data associated with the occupant to preset vehicle functions according to the action and identity characteristics of the vehicle occupant.

According to the present invention, there is provided a human-machine interaction method for a motor vehicle comprising:
detecting an action of a vehicle occupant and identifying identity characteristics of the vehicle occupant; and
activating one or more applications in at least one operable display area according to the action and identity characteristics of the vehicle occupant.

According to an embodiment of the present invention, the method further comprising:
identifying identity characteristics of the vehicle occupant according to the action of the vehicle occupant, wherein the identity characteristics includes at least one of a male or female driver, a male or female passenger, and an adult or a minor passenger.

According to an embodiment of the present invention, the applications comprise functional display and/or functional operation associated with an action and identity characteristics of an occupant, and activating one or more applications comprises magnifying the functional display of an application and/or opening the functional operation interface of an application.

According to an embodiment of the present invention, the action include line-of-sight, voice, touch, text input, facial expressions or actions, hand gestures or actions, head gestures or actions, and body gestures or actions.

According to an embodiment of the present invention, the method further comprising:
in response to detecting that a vector of vehicle occupant's line-of-sight is associated with at least one of a plurality of applications, determine occupant identity according to the vector and activate the application according to the association and the occupant identity.

According to an embodiment of the present invention, the method further comprising:
in response to detecting that a vector of vehicle occupant's line-of-sight is associated with at least one of a plurality of applications and the association is confirmed through at least one of gesture, voice, and posture within a preset time, activating the at least one application according to the association and identity of the vehicle occupant.

According to an embodiment of the present invention, the method further comprising: when the association between the line-of-sight vector and a first application is confirmed, if a second application is displayed in the at least one display area, then adaptively adjusting display position of at least one of the first application and the second application in the at least one display area.

According to an embodiment of the present invention, the method further comprising: in response to detecting that vectors of at least two vehicle occupants' line-of-sight are associated with applications, activating the application associated with the vehicle occupant with a higher priority according to priority setting of the identity characteristics.

According to an embodiment of the present invention, the method further comprising: applying personal preference settings and/or vehicle settings based on historical data according to the action and identity characteristics of the vehicle occupant.

According to an embodiment of the present invention, the method further comprising: self-adjust display characteristics of operable display area according to the characteristics of external environment and/or vehicle settings, and the display characteristics include at least one of brightness, saturation and contrast.
According to the present invention, there is also provided a motor vehicle comprising a human-machine interaction system for a motor vehicle comprising:
   a detection device configured to detect an action of a vehicle occupant; and
   an in-vehicle management system at least comprising:
      an interactive device comprising at least one operable display area configured to display one or more applications; and
      a processor communicatively connected to the detection device and configured to:
         identify identity characteristics of the vehicle occupant, and
         selectively activate the one or more applications in the at least one operable display area according to the action and identity characteristics of the vehicle occupant.

### BRIEF DESCRIPTION OF THE DRAWINGS

For a better understanding of the present invention, reference may be made to embodiments shown in the following drawings. The components in the drawings are not necessarily to scale and related elements may be omitted, or in some instances proportions may have been exaggerated, so as to emphasize and clearly illustrate the novel features described herein. In addition, system components can be variously arranged, as known in the art. Further in the figures, like referenced numerals refer to like parts throughout the different figures.

FIG. 1 shows a cabin of a motor vehicle including a human-machine interaction system according to the present invention;

FIG. 2 shows an exemplary block topology of an in-vehicle management system according to the present invention;

FIG. 3 shows a step flowchart of an embodiment of a human-machine interaction method using a human-machine interaction system according to the present invention;

FIG. 4 shows a schematic diagram of an operable display area of a human-machine interaction system according to the present invention;

FIG. 5 shows a schematic diagram of an interface of an application included in an embodiment of a human-machine interaction system according to the present invention;

FIG. 6 shows a schematic diagram of an interface of an application included in an embodiment of a human-machine interaction system according to the present invention;

FIG. 7 shows a schematic diagram of an interface of an application included in an embodiment of a human-machine interaction system according to the present invention;

FIG. 8 shows a step flowchart of an embodiment of a human-machine interaction method using a human-machine interaction system according to the present invention;

FIG. 9 shows a step flowchart of an embodiment of a human-machine interaction method using the human-machine interaction system according to the present invention; and

FIG. 10 shows a schematic diagram of an application program interface displayed in an operable display area of a human-machine interaction system according to the present invention.

### DETAILED DESCRIPTION

The embodiments of the present disclosure are described below. However, it should be understood that the disclosed embodiments are merely examples, and other embodiments may take various alternative forms. The drawings are not necessarily drawn to scale; some functions may be exaggerated or minimized to show details of specific components. Therefore, the specific structural and functional details disclosed herein should not be construed as restrictive, but merely serve as a representative basis for teaching those skilled in the art to use the present invention in various ways. As those of ordinary skill in the art will understand, the various features shown and described with reference to any one drawing can be combined with the features shown in one or more other drawings to produce embodiments that are not explicitly shown or described. The combinations of features shown provide representative embodiments for typical applications. However, various combinations and modifications to features consistent with the teachings of the present disclosure may be desirable for certain specific applications or implementations.

As mentioned in the background above, drivers is usually required to pay extra attention to interaction process and perform operation in the interaction process between a vehicle and a user, which may cause drivers to be unable to focus on driving behaviour, thus resulting in a reduction in the vehicle driving safety. However, in the current solutions, how to better understand vehicle driver' intentions and thereby present relevant functions and/or information to the vehicle driver has not been taken seriously, and the dialog interface and control interface of each application are often displayed superimposed on each other, making the overall effect more cluttered, and making driver or vehicle occupants feel unsmooth experience when they need to use these information or applications. Based on one or more problems in the prior art, the inventor of the present application provides a human-machine interaction system for a motor vehicle and corresponding vehicles and method in one or more embodiments, It is believed that it can solve the one or more problems in the prior art.

One or more embodiments of the present application will be described below in conjunction with the drawings. The flowchart describes the process performed by the system. It can be understood that the execution of the flowchart does not need to be performed in sequence, one or more steps can be omitted, one or more steps can also be added, and one or more steps can be performed in order or in reverse order, and even in some embodiments, can be performed simultaneously.

The following embodiments involve “driver”, “occupant”, “passenger” and “other clients of the same user”, etc, which is used to illustrate the interaction between vehicle and user in one or more embodiments, and in some cases, the roles can be exchanged or other names can be used without departing from the spirit of the present application.

The motor vehicle involved in the following embodiments may be a standard gasoline powered vehicle, a hybrid vehicle, an electric vehicle, a fuel cell vehicle, and/or any other types of vehicle, and may also be buses, ships, or aircraft. The vehicle includes components related to mobility, such as engines, electric motors, transmissions, suspensions, drive shafts, and/or wheels. The vehicle can be non-autonomous, semi-autonomous (for example, some conventional motion functions are controlled by the vehicle) or autonomous (for example, the motion functions are controlled by the vehicle without direct input from the driver).

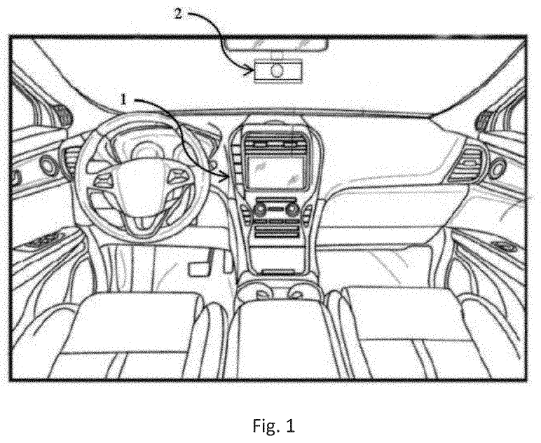

FIG. 1 shows a cabin of a motor vehicle according to the present invention comprising a human-machine interaction system 100 The human-machine interaction system 100 includes an in-vehicle management system 1 and a detection device 2 communicatively connected to the in-vehicle management system 1.

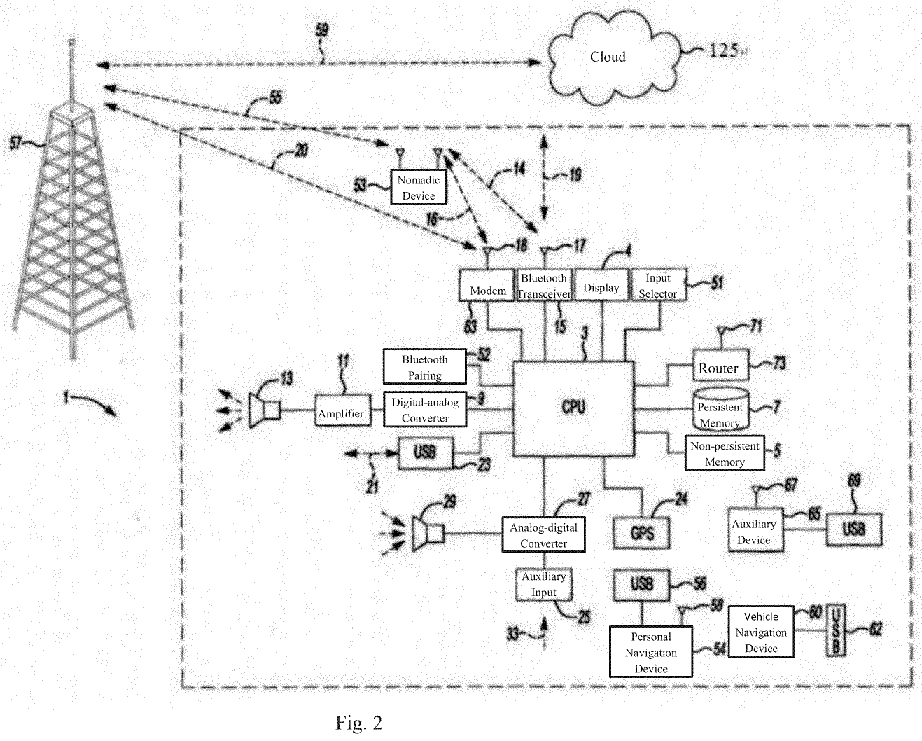

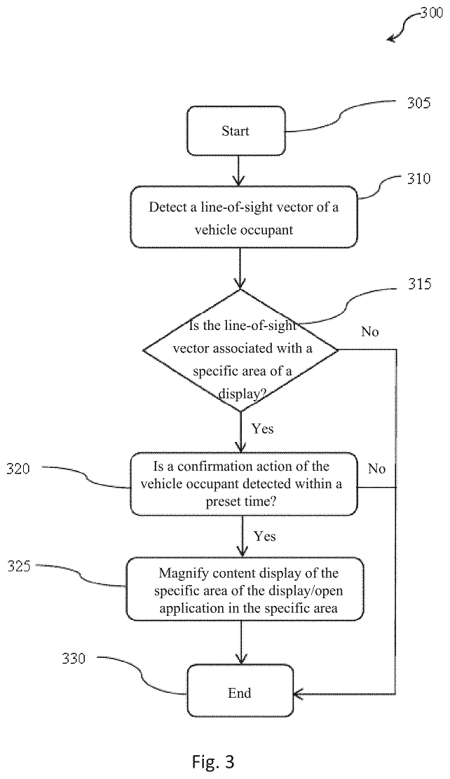

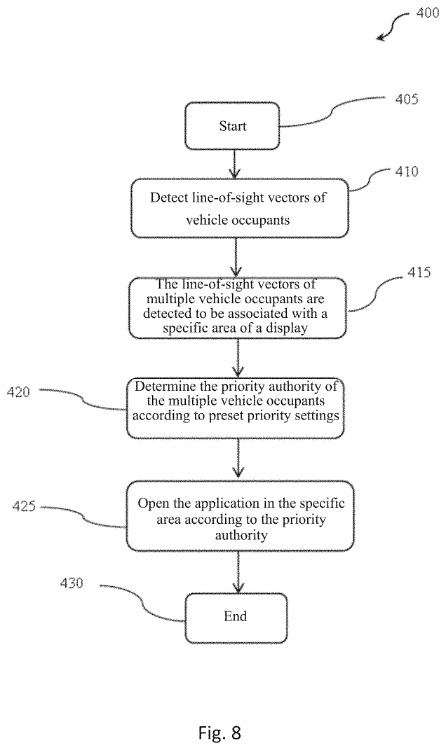

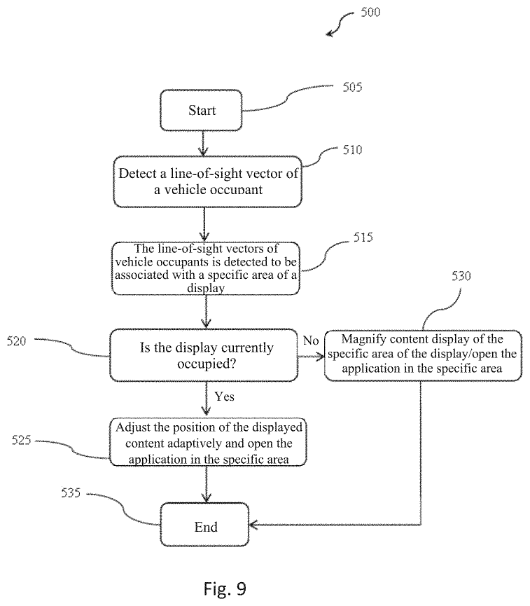

As further shown in the exemplary block topology of the in-vehicle management system 1 in FIG. 2, the in-vehicle management system 1 includes a processor 3 and a memory 7 storing processor-executable instructions which implement the steps shown in FIG. 3, FIG. 8 and FIG. 9 when executed by the processor 3.

Next, an exemplary hardware environment of the in-vehicle management system (also called a vehicle computing system (VCS)) 1 for a vehicle will be described in conjunction with FIG. 2. An example of the operating system installed in the in-vehicle management system 1 is SYNC system manufactured by Ford Motor Company. A vehicle equipped with the in-vehicle management system 1 may include a display 4 located in the vehicle. The number of the display 4 may be one or more to present individually or in conjunction vehicle information or content that interacts with the vehicle—for example, display of information related to vehicle and vehicle driving, and display and interaction of various applications installed in the in-vehicle management system. For example, but not limited, types of display can include CRT (Cathode Ray Tube) displays, LCD (Liquid Crystal) displays, LED (Light Emitting Diode) displays, PDP (Plasma Displays), laser displays, VR (Virtual Reality) displays, etc.

The processor (CPU) 3 in the in-vehicle management system 1 controls at least a part of its own operation. The processor 3 can execute on-board processing instructions and programs, such as the processor-executable instructions described for the in-vehicle management system 1 in the present invention. The processor 3 is connected to a non-persistent memory 5 and a persistent memory 7. The memories 5 and 7 may include volatile and non-volatile memories such as Read Only Memory (ROM), Random Access Memory (RAM) and Keep-Alive Memory (KAM), etc. Any number of known storage devices (such as Programmable Read Only Memory (PROM), EPROM (Electrically Programmable Read-only Memory), EEPROM (Electrically Erasable Programmable Read Only Memory), flash memory or any other electronic, magnetic, optical or combined storage devices capable of storing data) can be used to implement memories 5 and 7. The memories 5 and 7 may store instructions for execution by, for example, the processor of the in-vehicle management system 1.

The processor 3 is also provided with multiple different inputs to allow the user to interact with the processor. In an illustrative embodiment, the inputs include a microphone 29 configured to receive voice signals, an auxiliary input 25 for the input 33 (eg CD (Compact Disc), tape, etc.), a USB (Universal Serial Bus) input 23, a GPS (Global Positioning System) input 24, and a Bluetooth input 15. An input selector 51 is also provided to allow the user to switch among various inputs. The input of the microphone and auxiliary connector can be converted from an analog signal to a digital signal by a converter 27 before being passed to the processor. In addition, although not shown, a plurality of vehicle components and auxiliary components that communicate with the in-vehicle management system may use a vehicle network (such as but not limited to CAN (Controller Area Network) bus) to transfer data to or receive data from the in-vehicle management system 1 (or its components).

Additionally, the processor 3 may communicate with multiple vehicle sensors and drivers via an input/output (I/O) interface, which may be implemented as single integrated interface that provides multiple raw data or signal adjustment, processing and/or conversion, short-circuit protection, etc. Further, by way of example, but not limited, types of sensor in communication with the processor 3 may include cameras, ultrasonic sensors, pressure sensors, fuel level sensors, engine speed sensors, temperature sensors, photoplethysmography sensors, etc, to identify user interaction information such as button presses, voice, touch, text input, facial expressions or actions, hand gestures or actions, head gestures or actions, and body gestures or actions, as well as to identify vehicle information such as fuel level, powertrain system failure, temperature inside the vehicle, etc.

The output of the in-vehicle management system 1 may include, but is not limited to, the display 4, the speaker 13, and various actuators. The speaker 13 may be connected to an amplifier 11 and receive signal from the processor 3 through a digital-analog converter 9. The output of the system can also be output to a remote Bluetooth device (such as a personal navigation device 54) or a USB device (such as a vehicle navigation device 60) along the bidirectional data streams shown at 19 and 21, respectively.

In an illustrative embodiment, the in-vehicle management system 1 uses an antenna 17 of a Bluetooth transceiver 15 to communicate with a nomadic device 53 (eg, cellular phone, smart phone, personal digital assistant, etc.) of the user. The nomadic device 53 may in turn communicate 59 with the cloud 125 outside the vehicle 31 through, for example, communication 55 with a cellular tower 57. In some embodiments, the cellular tower 57 may be a Wi-Fi (Wireless Local Area Network) access point. Signal 14 represents an exemplary communication between the nomadic device 53 and the Bluetooth transceiver 15. The pairing 52 of the nomadic device 53 and the Bluetooth transceiver 15 can be instructed through a button or similar input, thereby indicating to the processor 3 that the in-vehicle Bluetooth transceiver will pair with the Bluetooth transceiver in the nomadic device.

For example, data-plan, data over voice, or Dual-Tone Multi-Frequency (DTMF) tones associated with the nomadic device 53 can be used to transfer data between the processor 3 and the cloud 125. Alternatively, the in-vehicle management system 1 may include an in-vehicle modem 63 having an antenna 18 to transfer 16 data between the processor 3 and the nomadic device 53 through a voice band. Subsequently, the nomadic device 53 can communicate 59 with the cloud 125 outside the vehicle 31 through, for example, communication 55 with a cellular tower 57. In some embodiments, the modem 63 may directly establish communication 20 with the cellular tower for further communication with the cloud 125. As a non-limiting example, the modem 63 may be a USB cellular modem and the communication 20 may be cellular communication.

In an illustrative embodiment, the processor is provided with an operating system including an API (Application Programming Interface) in communication with modem application software. The modem application software can access the embedded module or firmware on the Bluetooth transceiver 15 to complete wireless communication with a remote Bluetooth transceiver (for example, a Bluetooth transceiver in the nomadic device). Bluetooth is a subset of an IEEE 802 PAN (Personal Area Network) protocol. An IEEE 802 LAN (Local Area Network) protocol includes Wi-Fi and has a lot of cross-functionality with IEEE 802 PAN. Both of them are suitable for wireless communication in vehicles. Other communication methods can include free-space optical communication (for example, Infrared Data Association, IrDA) and non-standard consumer infrared (consumer IR) protocols, and so on.

In an embodiment, the nomadic device 53 may be a wireless Local Area Network (LAN) device capable of communicating via, for example, an 802.11 network (for example, Wi-Fi) or a WiMax (Worldwide Interoperability Microwave Access) network. Other sources that can interact with the vehicle include a personal navigation device 54 with, for example, a USB connection 56 and/or antenna 58, or a vehicle navigation device 60 with a USB 62 or other connection, an on-board GPS device 24, or a remote navigation system (not shown) connected to the cloud 125.

In addition, the processor 3 can communicate with a number of other auxiliary devices 65. These devices can be connected via a wireless connection 67 or a wired connection 69. Likewise or alternatively, the CPU may connect to a vehicle-based wireless router 73 using, for example, a Wi-Fi 71 transceiver. This may allow the CPU to connect to a remote network within the range of the local router 73. The auxiliary device 65 may include, but is not limited to, a personal media player, a wireless health device, a mobile computer, and so on.

Specifically, the concept of the present invention will be further explained below with reference to FIG. 3, which shows a step process 300 implemented when executable instructions included in an embodiment of the human-machine interaction system 1 according to the present invention are executed.

The process 300 starts from block 305, and the start of the process 300 is based on, for example, but not limited to, any moment when the in-vehicle management system 1 detects that the user is inside the vehicle. In an example, the occupant inside the vehicle is detected by the on-board management system 1 through the pairing of sensors such as microphones, cameras, touch sensors, pressure sensors, or nomadic devices. In one example, the seat pressure can be sensed by a pressure sensor in a vehicle seat to determine whether an occupant is already seated on the vehicle seat.

Subsequently, the process 300 proceeds from block 305 to block 310, When it is determined that the vehicle occupant is inside the vehicle, detect a vector of line-of-sight of the vehicle occupant by the detection device 2, in an example, the detection device 2 may be a line-of-sight detection system including a gaze tracking calculation unit, a lighting device, and a camera device. The gaze tracking calculation unit is configured to receive line-of-sight data from the camera device and perform calculations to determine the line-of-sight vector of gaze position of the vehicle occupant including, but not limited to, driver and passenger. In an example, the lighting device may be an infrared lighting device for detecting the line-of-sight vector of the vehicle occupant at night. And in an example, the line-of-sight detection system communicates with the in-vehicle management system 1 through an input interface and sends the line-of-sight vector data to the in-vehicle management system 1.

Subsequently, in block 315, the in-vehicle management system 1 determines that whether the line-of-sight vector of the vehicle occupant points to a certain operable display area of the interactive device through the calculation performed by the processor 3 according to the received line-of-sight vector data.

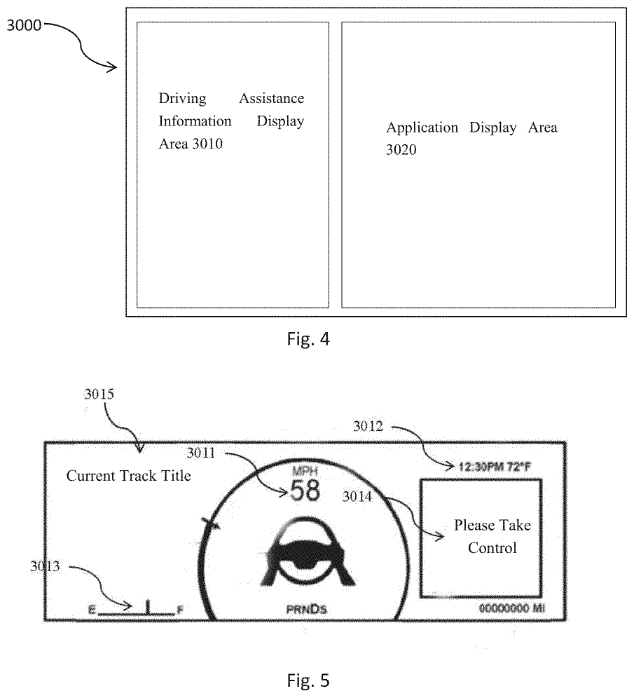

In an example, the interactive device is at least one display 4 of the in-vehicle management system 1. In this embodiment, the display 4 is an interactive display capable of touch input, and its display area may be divided into multiple operable display areas for displaying different contents. As shown in FIG. 4, in an example, the display 4 is divided into two areas, namely a driving assistance information display area 3010 and an application display area 3020. It should be understood that the interactive area of the display 4 can also be divided according to the needs of vehicle occupant and is not limited to the division method in this embodiment. In the driving assistance information display area 3010, various information related to the vehicle driver can be displayed. It can also be understood that the interactive device may also be multiple displays 4, which serve as multiple operable display areas for displaying different content. It should also be understood that in one or more embodiments of the present invention, “app” or “application” may include various operating functions associated with vehicle components displayed on the interactive device, including but not limited to, vehicle air conditioning control, in-vehicle entertainment system control, carplay control, etc., as well as various applications developed by third parties that can be installed through the in-vehicle management system 1, including but not limited to, AutoNavi Map, Weibo, WeChat, Zhihu, Tencent Video, NetEase Cloud Music, etc.

For example, as shown in FIG. 5, in an example, the motor vehicle may be an autonomous vehicle, and the operation of the vehicle is implemented by the in-vehicle management system 1 during normal driving. In this case, the driving assistance information display area 3010 may display information related to the overtaking operation when the vehicle performs the overtaking operation. At this time, the content displayed in the driving assistance information display area 3010 includes speed display 3011, time and temperature display 3012, fuel display 3013, prompt information display 3014, entertainment content display 3015, and the like. When the vehicle needs to perform a lane change operation, the driver is prompted by the vibration of the steering wheel and a message is displayed on the prompt information display 3014 to instruct the driver to perform vehicle manipulation.

If the processor 3 determines according to the line-of-sight vector of the vehicle occupant that the driver is looking at, for example, the prompt information display 3014, the process proceeds to block 320 to continuously detect that whether the driver makes a confirmation action within a preset time range (for example, 0.5 to 2 seconds), the confirmation action here may include any one or more of voice, touch, text input, facial expressions or actions, hand postures or actions, head postures or actions, and body postures or actions. It should be understood that the confirmation step in the method process of this embodiment is only an example, and the display of the corresponding area can be magnified only based on the association between the line-of-sight vector and the display area, and the confirmation action is not an indispensable step. The in-vehicle management system 1 can identify these actions through the aforementioned sensors, for example, a microphone, a camera, a touch sensor, an ultrasonic sensor, and so on. The processor 3 of the in-vehicle management system 1 may receive the input of sensor to identify the user's voice, touch, text input, predetermined postures or actions, and obtain user interaction information therefrom. If at least one of the above confirmation actions is detected within the preset time range, the method proceeds to block 325. In this example, the prompt information display 3014 in the driving assistance information display area 3010 is activated, such as the information content displayed is magnified, In order to facilitate the driver to view, thereby providing a better interactive experience. It can be understood that in one or more embodiments of the present application, “activating” the display area includes but is not limited to multiple operations such as magnifying the content displayed in the functional display area and adjusting the brightness, and also includes opening the application associated with the line-of-sight of the vehicle occupant in the functional display area. Those skilled in the art can understand that the information that can be magnified is not limited to text information, graphics, images, and other information that can be displayed on the display 4 can all be magnified based on the association with the driver's line-of-sight vector, and when the line-of-sight vector of driver is associated with display content of other areas, the display content of the corresponding area can also be magnified. It should also be understood that operations performed based on the association of the driver's line-of-sight vector and information are not limited to magnification operations. In an example, when the driver's line-of-sight vector is associated with information in the display area, the screen brightness and contrast of the display area can also be adjusted, for example, by increasing the brightness of the information and reducing the brightness of the background content to make the information more clearly displayed. At the same time, it should be understood that the brightness adjustment and magnification operations of information can be performed simultaneously or can be selectively performed either.

The “association” between the user and the application as described herein or elsewhere can refer to establishing a connection between the two. In one embodiment, the association relationship between an application and a specific user can be identified by pre-entry, for example, social software associated with a person with specific identity characteristics, preference applications; specific seat position temperature adjustment seat adjustment, navigation applications, etc. can be preset so that the association can be identified. In one embodiment, the user's line-of-sight can trigger a process of the application being activated in the background in advance, the application is not activated immediately, but will be triggered until the subsequent “confirmation”, to perform the above-mentioned magnifying or lighting, increasing the contrast and other operations, in order to avoid undesired interference to the display interface of the current vehicle, or misoperation and false triggering.

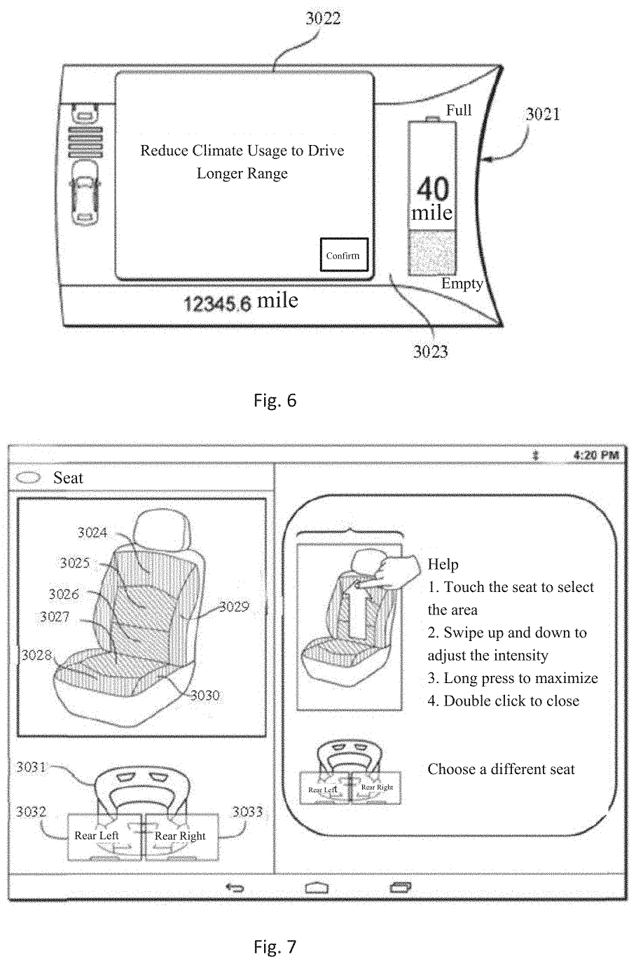

In another example, at block 315, according to the received line-of-sight vector data, the in-vehicle management system 1 determine that the vehicle occupant's line-of-sight vector points to a specific application in the application display area 3020 through the calculation performed by the processor 3, then the association between the vehicle occupant's line-of-sight vector and the application is established at this time, in this embodiment, the specific application is energy management application shown in FIG. 6. At this point, the process proceeds to block 320. At block 320, detect that whether the driver has made a confirmation action within a preset time range (for example, 0.5-2 seconds), the confirmation action here may include any one or more of voice, touch, text input, facial expressions or actions, and hands postures or actions, head postures or actions, and body postures or actions. For example, the driver may indicate confirmation through actions including but not limited to voice confirmation, touch confirmation button, hand movement, and nodding. After the confirmation action is detected, the process proceeds to block 325, and the energy management application 3021 is opened and displayed in the application display area 3020. As shown in FIG. 6, the interface after opening the energy management application 3021 includes an energy suggestion message bar 3022 and a vehicle battery status display 3023, for example, when the vehicle battery status cannot meet the next travel requirements, an energy suggestion message bar 3022 pops up in the application interface, giving the driver one key to adjust the power distribution of the vehicle battery to reduce the use of the air conditioning system to promote the vehicle more. It can be understood that the display interface after entering the application program can also allow magnifying the information display of the relevant area and/or adjusting the brightness and contrast thereof according to the association and confirmation of the driver and the relevant area on the interface, and the confirmation operation in the application can be performed by any one or more of including voice, touch, text input, facial expressions or actions, hand gestures or actions, head gestures or actions, and body gestures or actions.

In the concept of the present invention, the interface of the application itself refers to the user interface (UI) of the application itself, in which the complete function control of the application can be provided.

In another example, as shown in FIG. 7, according to the received line-of-sight vector data, the in-vehicle management system 1 determine that the vehicle occupant's line-of-sight vector points to the seat massage function application in the application display area 3020 through the calculation performed by the processor 3, then the association between the vehicle occupant's line-of-sight vector and the seat massage application is established at this time. Also at block 320, detect that whether the driver has made a confirmation action within a preset time range (for example, 0.5-2 seconds), the confirmation action here can include any one or more of voice, touch, text input, facial expressions or actions, hand postures or actions, head postures or actions, and body postures or actions. For example, the driver may indicate confirmation through actions including but not limited to voice confirmation, touch confirmation button, hand movement, and nodding. After the confirmation action is detected, the process proceeds to block 325, and the seat massage application is opened and displayed in the application display area 3020. As shown in FIG. 7, the interface after opening the seat massage application includes a massage area selection 3024-3030, a seat selection 310, and a function guide area 3034. The vehicle occupant can select the seat that needs to start the massage function as required by clicking 3032 or 3033 according to the guidance of the function guide area 3034, and select the corresponding massage area to start the massage function by clicking any one or more of 3024-3030.

In addition, it can be understood that the processor 3 can determine the identity characteristics of the vehicle occupant according to the line-of-sight vector, for example, determine that whether the vehicle occupant is the driver based on the line-of-sight vector from driver's seat side or co-pilot side. And in the above-mentioned embodiment, it can be provided that only when the identity of the vehicle occupant is determined to be the driver, the driving assistance information in the driving assistance information display area 3010 will be magnified and/or the brightness will be adjusted, and it can be provided that selectively opening the application in the application display area 3020 according to the identity of the vehicle occupant. For example, when the association between the line-of-sight vector of the vehicle occupant of the non-driver and the energy management application 3021 is detected, the detection of subsequent confirmation actions and the opening of the energy management application 3021 will not be performed.

It can be understood that the processor 3 can also determine the identity characteristics of the vehicle occupant based on the information obtained by other sensors, for example, the gender, age and other identity characteristics of the vehicle occupant can be determined by facial features, voice frequency, and physical characteristics.

In an embodiment, other vehicle functions can also be controlled according to the identity characteristics of the vehicle occupant. For example, when an association between the vehicle occupant and the vehicle air conditioning system is detected, the processor 3 can selectively activate the air conditioning adjustment interface on the driver's side or the co-pilot's side depending on whether the vehicle occupant is the driver or passenger, so as to provide more convenience and personalized operating experience. It can be understood that other vehicle functions can also be provided based on the identity characteristics of the vehicle occupant according to the above method, for example, the in-vehicle management system can push entertainment content or advertising content according to the gender and age of the occupant, so as to provide a better interactive experience for the vehicle occupant.

The concept of the present invention will be further explained with reference to FIG. 8, which shows a step process 400 implemented when executable instructions included in another embodiment of the human-machine interaction system according to the present invention are executed.

The process 400 starts from block 405, and the start of the process 400 is also based on, for example, but not limited to, any moment when the in-vehicle management system 1 detects that the user is inside the vehicle.

Subsequently, the process 400 proceeds from block 405 to block 410, when it is determined that the vehicle occupant is inside the vehicle, detect a vector of line-of-sight of the vehicle occupant by the line-of-sight detection system 2. The line-of-sight detection system 2 includes a gaze tracking calculation unit configured to receive line-of-sight data from the camera device and perform calculations to determine the line-of-sight vector of the gaze position of the vehicle occupant. The line-of-sight detection system communicates with the in-vehicle management system 1 through an input interface and sends the line-of-sight vector data to the in-vehicle management system 1.

Subsequently, in block 415, the in-vehicle management system 1 determine that whether the line-of-sight vector of the vehicle occupant points to an certain operable display area of the interactive device through the calculation performed by the processor 3 according to the received line-of-sight vector data. In this embodiment, the in-vehicle management system 1 determines that the line-of-sight vectors of the driver and the occupant are associated with different applications in the application display area 3020 according to the received line-of-sight vector data.

Based on the above determination, the process continues to block 420. In block 420, the processor 3 retrieves the user profile, in which the priority authority of the vehicle occupants is preset; the driver has the highest priority in this embodiment. It can be understood that a priority authority setting different from those in this embodiment can be set according to user requirements.

Subsequently, in block 425, the processor 3 opens the application associated with the driver's line-of-sight vector and adds the application associated with the passenger to the waiting sequence according to the priority authority set in the user profile, and after the application is used by the driver, the processor 3 sequentially opens the application in the waiting sequence. It can be understood that when it is detected that multiple vehicle occupants with the same priority authority are associated with the application, the opening sequence of the application can be sorted according to the time sequence in which different occupants are associated with the application. It can also be understood that the processor 3 may also only process the needs of the vehicle occupant with the highest priority authority and ignore the needs of other occupants when the vehicle occupant uses the interactive device.

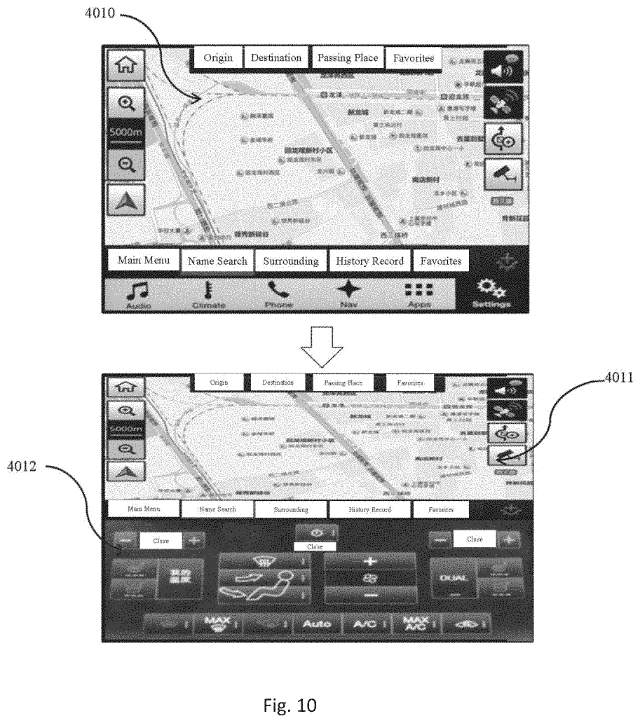

Next, referring to FIG. 9 and FIG. 10, there is shown a step process 500 implemented when executable instructions included in another embodiment of the human-machine interaction system according to the present invention are executed.

The process 500 starts from block 505 and the start of the process 500 is also based on, for example, but not limited to, any moment when the in-vehicle management system 1 detects that the user is inside the vehicle.

Subsequently, the process 500 proceeds from block 505 to block 510, when it is determined that the vehicle occupant is inside the vehicle, detect the vector of vehicle occupant' line-of-sight by the line-of-sight detection system 2. The line-of-sight detection system 2 includes a gaze tracking calculation unit configured to receive line-of-sight data from the camera device and perform calculations to determine the line-of-sight vector of the gaze position of the vehicle occupant. The line-of-sight detection system 2 communicates with the in-vehicle management system 1 through an input interface and sends the line-of-sight vector data to the in-vehicle management system 1.

Subsequently, in block 515, the in-vehicle management system 1 determine that the vehicle occupant's line-of-sight vector points to an certain operable display area of the interactive device through the calculation performed by the processor 3 according to the received line-of-sight vector data, and in this embodiment, it is detected that the vehicle occupant's line-of-sight vector is associated with “climate” in the vehicle basic function bar below the display area.

Based on the above determination, the process continues to block 520. In block 520, the processor 3 determines that whether the display area of the display 4 is currently occupied. If the judgment result is “yes”, that is, as the situation shown in FIG. 10, the display area 4010 of the display 4 is completely occupied by the navigation application, then the process proceeds to block 525, the processor 3 controls display area of the navigation application and adaptively reduces it to display area 4011, and opens the air conditioning system adjustment interface according to the association and displays it in another display area 4012. If the judgment result in block 520 is “no”, the process proceeds to block 530, normally open the air conditioning system adjustment interface.

Through this adjustment method, the adjustment operation of the air conditioning system is carried out at the same time without affecting the driver's use to navigation information, which improves the experience of the vehicle occupant.

In addition, in another embodiment of the present application, when it is detected that the vehicle occupant is associated with “climate” in the basic function bar below the display area, but the display area of the display 4 is occupied, only a simple adjustment control interface can pop up at the border of the display area 4010 without changing the control interface of the navigation application, for example, only the temperature and air volume increase and decrease keys pop up, in this way, the simple control interface that pops up will only cause a small amount of occlusion at the border of the navigation interface, the impact of the pop-up control interface on the driver's use to the navigation application is minimized and the driver's good driving experience is ensured.

Further, according to several embodiments of the present invention, the in-vehicle management system 1 can save the history record of the application in a user profile, and the in-vehicle management system 1 can obtain the user profile uploaded by other clients (also called nomadic device) 53 of the same user from the cloud 125 and update the local user profile based on the obtained user profile for retrieval by the in-vehicle management system 1.

In the concept of the present invention, the user profile can include personal information such as the historical progress, preferences and settings of the application used by the user, the user's vehicle preferences, information query preferences, etc., as well as include interactive information from the user, pre-set events, and the history records of corresponding feedback information. In this way, when the user switches from other clients 53 to the vehicle 100, the interaction process he performed before can be seamlessly connected through the in-vehicle management system 1, thereby improving the user experience. Wherein, the number of the other clients 53 may be one or more, and may be the user's nomadic device or the in-vehicle management system 1 of other vehicles.

Further, according to several other embodiments of the present invention, the in-vehicle management system 1 can save the history record of the application in the user profile and synchronize it to the cloud 125 for other clients 53 of the same user to obtain. Similarly, when a user switches from the in-vehicle management system 1 to other clients 53, his/her interaction process with applications, other user interaction interfaces, or vehicle management systems can be seamlessly connected, which further improves the user experience.

Further, according to several other embodiments of the present invention, the in-vehicle management system 1 can adjust display characteristics of the operable display area according to external environment, for example, adjust the brightness, saturation, and contrast of the display area according to changes in external light. Or adjust the information display mode of the display area according to the settings of the vehicle, including but not limited to, displaying the information that the vehicle occupant expects to view at brightness higher than the background environment, etc.

In summary, compared with the prior art, the present invention proposes a human-machine interaction system and corresponding vehicle and interactive method, which can integrate existing applications, functions and information in the interactive interface, providing a safer and more convenient interaction way between vehicles and users, and significantly improving the interaction efficiency with users and user satisfaction.

Where it is technically possible, the technical features listed in relation to different embodiments can be combined with each other to form further embodiment within the scope of the present invention.

In this application, the use of the disjunctive is intended to include the conjunctive. The use of definite or indefinite articles is not intended to indicate cardinality. In particular, a reference to “the” object or “a” and “an” object is intended to denote also one of a possible plurality of such objects. Further, the conjunction “or” may be used to convey features that are simultaneously present instead of mutually exclusive alternatives. In other words, the conjunction “or” should be understood to include “and/or”. The term “including” is inclusive and has the same scope as “comprising”.

The above-mentioned embodiments are possible examples of implementations of the present invention and are given only for the purpose of enabling those skilled in the art to clearly understand the principles of the invention. It should be understood by those skilled in the art that the above discussion to any embodiment is only illustrative, and is not intended to imply that the disclosed scope of the embodiments of the present invention (including claims) is limited to these examples; under the overall concept of the invention, the technical features in the above embodiments or different embodiments can be combined with each other to produce many other changes in different aspects of embodiments of the invention that is not provided in detailed description for the sake of brevity. Therefore, any omission, modification, equivalent replacement, improvement, etc. made within the spirit and principle of the embodiment of the invention shall be included in the scope of protection claimed by the invention.

1. A human-machine interaction system for a motor vehicle, comprising:
a detection device configured to detect an action of a vehicle occupant; and
an in-vehicle management system comprising:
an interactive device comprising at least one operable display area configured to display one or more applications; and
a processor communicatively connected to the detection device and configured to:
identify identity characteristics of the vehicle occupant, and
selectively activate the one or more applications in the at least one operable display area according to the action and identity characteristics of the vehicle occupant.

2. The human-machine interaction system of claim 1, wherein the one or more applications comprise a functional display and/or a functional operation associated with an action and identity characteristics of an occupant, and the processor is configured to activate the one or more applications by magnifying the functional display of an application and/or opening the functional operation interface of an application.

3. The human-machine interaction system of claim 2, wherein the processor is configured to identify the identity characteristics of the vehicle occupant according to the action of the vehicle occupant, and the identity characteristics include at least one of a male or female driver, a male or female passenger and an adult or a minor passenger.

4. The human-machine interaction system of claim 1, wherein the action includes line-of-sight, voice, touch, text input, facial expressions or actions, hand gestures or actions, head gestures or actions, and body gestures or actions.

5. The human-machine interaction system of claim 2, wherein the detection device is configured to detect an association between the action and at least one application and a confirmation of the association, and send the association and confirmation to the processor.

6. The human-machine interaction system of claim 5, wherein the processor is configured to selectively activate the at least one application according to the association and confirmation acquired within a predetermined time and the identity characteristics of the vehicle occupant.

7. The human-machine interaction system of claim 4, wherein the processor is configured to, in response to the detection device detects that a vector of the line-of-sight is associated with at least one of a plurality of applications, determine occupant identity according to the vector and activate the application according to the association and the occupant identity.

8. The human-machine interaction system of claim 7, wherein the processor is configured to, in response to the detection device detects that vectors of at least two vehicle occupants' line-of-sight are associated with one or more applications, activate the application associated with the vehicle occupant with a higher priority according to a preset identity characteristics priority.

9. The human-machine interaction system of claim 1, wherein the processor is configured to receive and store personal preference settings preset by the vehicle occupant, and apply the personal preference settings according to the action and identity characteristics of the vehicle occupant.

10. The human-machine interaction system of claim 1, wherein the processor is configured to use historical data associated with the occupant to preset vehicle functions according to the action and identity characteristics of the vehicle occupant.

11. A human-machine interaction method for a motor vehicle, comprising:
detecting an action of a vehicle occupant;
identifying identity characteristics of the vehicle occupant; and
activating one or more applications in at least one operable display area according to the action and identity characteristics of the vehicle occupant.

12. The human-machine interaction method of claim 11, further comprising:
identifying identity characteristics of the vehicle occupant according to the action of the vehicle occupant, wherein the identity characteristics includes at least one of a male or female driver, a male or female passenger, and an adult or a minor passenger.

13. The human-machine interaction method of claim 12, wherein the applications comprise functional display and/or functional operation associated with an action and identity characteristics of an occupant, and activating one or more applications comprises magnifying the functional display of an application and/or opening the functional operation interface of an application.

14. The human-machine interaction method of claim 11, wherein the action includes line-of-sight, voice, touch, text input, facial expressions or actions, hand gestures or actions, head gestures or actions, and body gestures or actions.

15. The human-machine interaction method of claim 14, further comprising:
in response to detecting that a vector of vehicle occupant's line-of-sight is associated with at least one of a plurality of applications, determine occupant identity according to the vector and activate the application according to the association and the occupant identity.

16. The human-machine interaction method of claim 14, further comprising:
in response to detecting that a vector of vehicle occupant's line-of-sight is associated with at least one of a plurality of applications and the association is confirmed through at least one of gesture, voice, and posture within a preset time, activating the at least one application according to the association and identity of the vehicle occupant.

17. The human-machine interaction method of claim 16, further comprising:
when the association between a vector of the line-of-sight and a first application is confirmed, if a second application is displayed in the at least one display area, then adaptively adjusting display position of at least one of the first application and the second application in the at least one display area.

18. The human-machine interaction method of claim 15, further comprising:
in response to detecting that vectors of at least two vehicle occupants' line-of-sight are associated with applications, activating the application associated with the vehicle occupant with a higher priority according to priority setting of the identity characteristics.

19. The human-machine interaction method of claim 11, further comprising:
applying personal preference settings and/or vehicle settings based on historical data according to the action and identity characteristics of the vehicle occupant.

20. A motor vehicle, comprising a human-machine interaction system for a motor vehicle comprising:
a detection device configured to detect an action of a vehicle occupant; and
an in-vehicle management system comprising:
an interactive device comprising an operable display area configured to display an application; and
a processor communicatively connected to the detection device and configured to:
identify identity characteristics of the vehicle occupant, and
selectively activate the application in the operable display area according to the action and identity characteristics of the vehicle occupant.
